(19) United States
(12) Patent Application Publication
(10) Pub. No.: US 2004/0151636 A1
(43) Pub. Date: Aug. 5, 2004

(54) Quantitative collecting and depositing device for very small fluids

(75) Inventors: Chi-Hsiung Hsu, Yangmei Jer Taoyuan (TW); Wu-Tsai Liao, Yangmei Jer Taoyuan (TW)

Correspondence Address: BACON & THOMAS, PLLC, 625 SLATERS LANE, FOURTH FLOOR, ALEXANDRIA, VA, 22314

(73) Assignee: SHUAI RAN PRECISION CORP., Yangmei Jer Taoyuan (TW)

(21) Appl. No.: 10/356,596

(22) Filed: Feb. 3, 2003

(51) Int. Cl. B01L 3/00

(52) U.S. Cl. 422/100

(57) ABSTRACT

The quantitative collecting and depositing device for very small fluids of the invention, through precise controls of an XYZ triaxial AC servo controller and quantitative depositing valves through a main PC base controller or a program logic controller (PLC), is able to simultaneously control movements of the XYZ triaxial AC servo controller 4 and the open-and-shut of the quantitative depositing valves. Therefore the invention may be applied in non-contact, high-speed and high-accuracy sampling and precise fluid dividing in biochips. In addition, a cleaning device and a drying device provided by the invention are capable of preventing congestions of the pipelines and cross-contaminations thereof, such that cross-contaminations are not incurred in biochips during sampling (such as protein and DNA) and precise fluid dividing (such as protein, DNA and enzymes).

### BACKGROUND OF THE INVENTION

(a) Field of the Invention

The invention relates to a quantitative collecting and depositing device for very small fluids, and more particularly, to a quantitative collecting and depositing device for very small fluids used in non-contact, high-speed and high-accuracy sampling and precise fluid dividing in biochips. In addition, cleaning and drying devices thereof are capable of preventing congestions of pipelines and cross-contaminations of fluids therein.

(b) Description of the Related Art

In a prior quantitative collecting and depositing device for fluids, a pump 100 is used for collecting a fluid from a fluid reservoir 200, and the fluid collected is forwarded into a depositing device 400 after flowing through a flow control valve 300. The depositing device 400 controls the quantity to be deposited through the flow control valve 300 without being able to precisely control the quantity of the fluid collected and deposited.

### SUMMARY OF THE INVENTION

An object of the invention is to provide a quantitative collecting and depositing device for non-contact, high-speed and high-accuracy sampling and precise fluid dividing in biochips.

The other object of the invention is to provide a cleaning device and a drying device for preventing congestions of pipelines and cross-contaminations of fluids therein, such that cross-contaminations of samples are not incurred during sampling and precise fluid dividing in biochips.

### BRIEF DESCRIPTION OF THE DRAWINGS

FIG. 1 shows a schematic view of the mechanism in accordance with the invention.

FIG. 2 shows a block diagram of the controller in accordance with the invention.

FIG. 3 shows a block diagram of an embodiment in accordance with the invention.

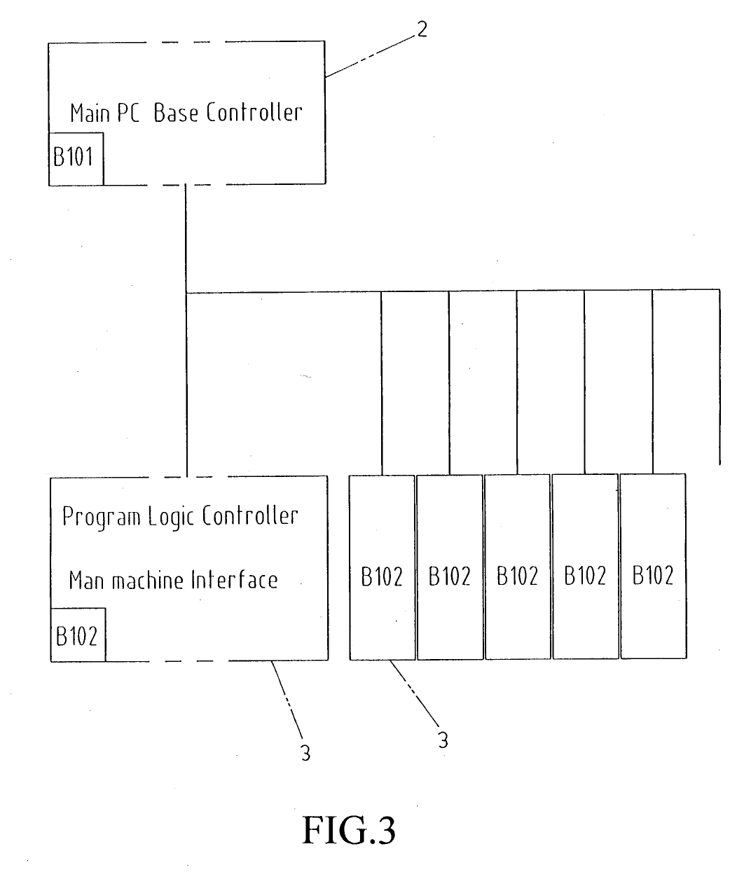

FIG. 4 shows a conventional schematic of a prior product.

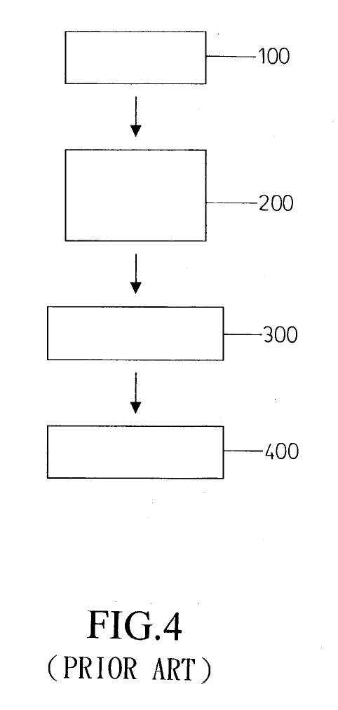

### DESCRIPTION OF THE PREFERRED EMBODIMENTS

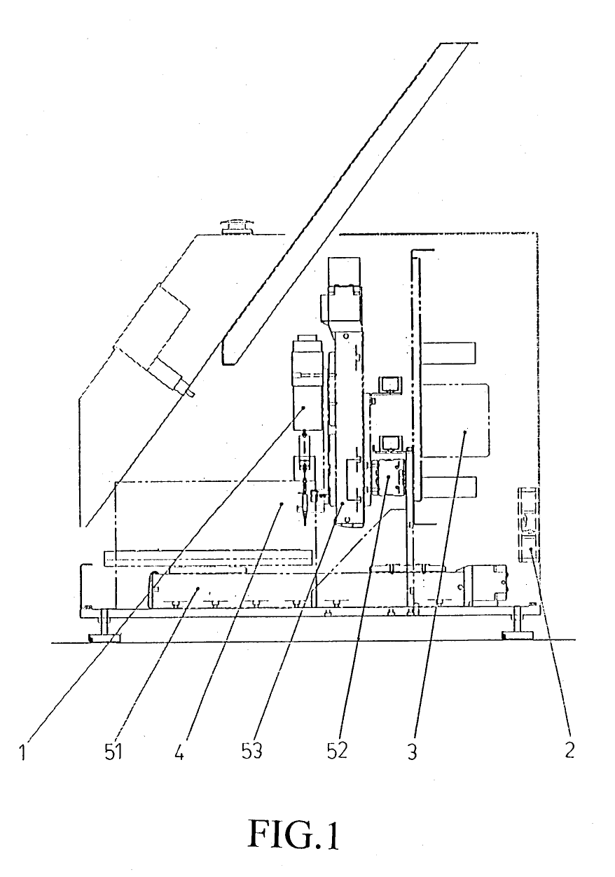

Referring to FIG. 1, the invention comprises a circuit mechanism 1, a main PC base controller 2, a program logic controller (PLC) 3, a servo controller 4 and a servo robot 5. Wherein, the servo robot 5 is divided into X-axis robot 51, Y-axis robot 52 and Z-axis robot 53.

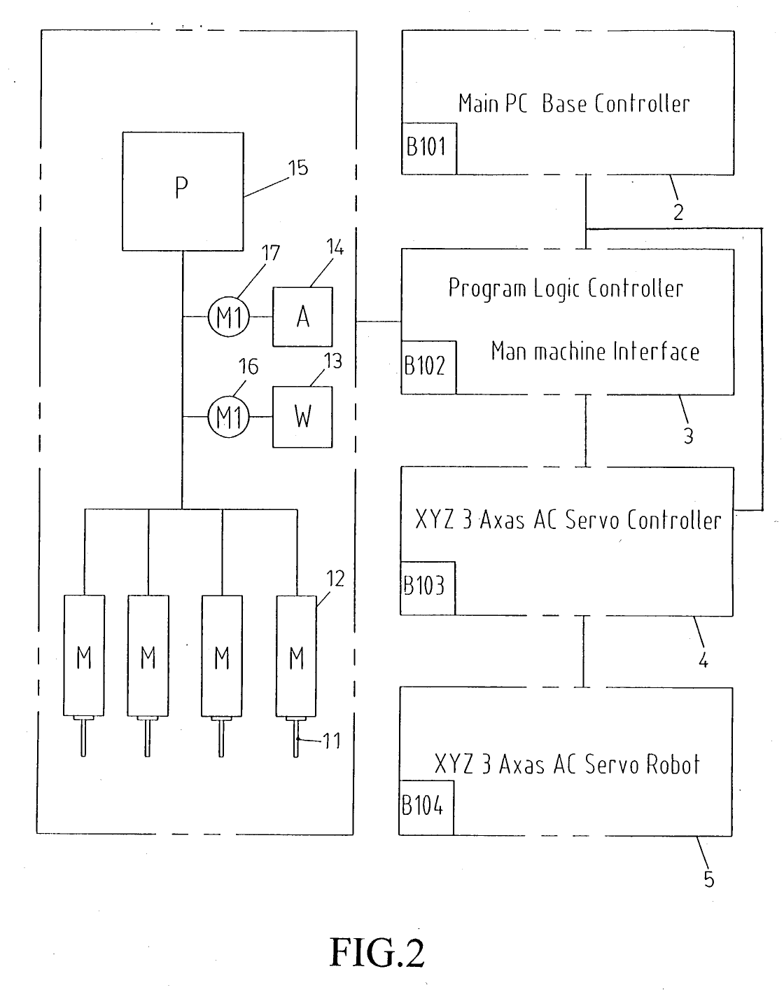

Referring to FIG. 2, the circuit mechanism 1 consists of a plurality of nozzles 11, a plurality of high-speed, quantitative depositing valves 12, high-pressure water 13, high-pressure air 14, a collecting device 15 and two electromagnetic valves 16 and 17. The replaceable nozzles 11 are disposed within the high-speed, quantitative depositing valves 12 that are perpetually shut, respectively. The collecting device 15 is composed of a stepper motor and is connected to the two electromagnetic valves 16 and 17 through pipelines and a plurality of high-speed, quantitative depositing valves 12. The high-pressured water 13 and the high-pressure air 14 are controlled by the perpetually shut electromagnetic valves 16 and 17, respectively.

Referring to FIG. 2, a controlling system controls the PLC 3 through the main PC base controller 2, and the XYZ triaxial AC servo controller 4 is controlled through the PLC 3. The servo controller 4, through precise controlling by the XYZ triaxial AC servo controller 4 and the quantitative depositing valves 12 in the circuit mechanism 1, is able to simultaneously control the movements of the XYZ triaxial AC servo controller 4 and the open-and-shut of the quantitative depositing valves 12. Therefore the invention may be applied in non-contact, high-speed and high-accuracy sampling and precise fluid dividing in biochips.

The aforesaid control system may also be a structure that directly controls the XYZ triaxial AC servo controller 4, the XYZ triaxial AC servo robot 5, the quantitative depositing valves 12 in the circuit mechanism 1 and the two electromagnetic valves 16 and 17.

When collecting quantitatively, the quantitative depositing valves 12 are in an open status, and the electromagnetic valves 16 and 17 are in a perpetually open status. The collecting device 15 collects quantitative fluids through the main PC base controller or the PLC 3 and forms barotropy in the pipelines.

When depositing quantitatively, the quantitative depositing valves 12 are in a perpetually shut status, and the electromagnetic valves 16 and 17 are in a perpetually shut status as well. The collecting device 15 controls the amount of intake collected by the stepping motor in the collecting device 15 through the main PC base controller 2 or the PLC 3. The amount of fluids discharged varies due to pressure changes when opening at a high speed, and therefore by adjusting the diameter of the nozzles 11 and the open-and-shut timings of the quantitative depositing valves 12, the volume and diameter of discharged fluids may be changed accordingly.

When cleaning the pipelines, the quantitative valves 12 are in an open status, and the electromagnetic valves 16 and 17 are in a perpetually open status. The pipelines are rinsed and cleaned by the high-pressure water 13 and the high-pressure air 14 through controlling of the main PC base controller 2 or the PLC 3.

When the pipelines are dry, the quantitative valves 12 are in an open status, and the electromagnetic valve 16 is in a perpetually shut status whereas the other electromagnetic valve 17 is in a perpetually open status. The pipelines are dried by the high-pressure 14 for removing the remaining fluids in order to prevent congestions of the pipelines and cross-contaminations of different fluids.

Conclusive from the above, the invention may be applied to non-contact, high-speed and high-accuracy sampling and precise fluid dividing in biochips. The cleaning device and drying device thereof are capable of preventing congestions of the pipelines thereof and cross-contaminations of different fluids, such that cross-contaminations of samples are not incurred during sampling and precise fluid dividing in biochips.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A quantitative collecting and depositing device for very small fluids comprising:
a circuit mechanism consisted of a plurality of nozzles, a plurality of quantitative depositing valves, high-pressure water, high-pressure air, a collecting device and two electromagnetic valves; wherein the replaceable nozzles are disposed in the high-speed depositing valves that are perpetually shut, respectively, the collecting device is formed from a stepping motor and is connected to the two electromagnetic valves and the quantitative depositing valves through pipelines, and the high-pressure water and the high-pressure air are controlled by the perpetually shut electromagnetic valves, respectively;
a main PC base controller;
a program logic controller (PLC) controllable through the main PC base controller;
a servo robot divided into X-axis, Y-axis and Z-axis robots that are controllable through the PLC; and
the quantitative collecting and depositing device described above may be applied in non-contact, high-speed and high-accuracy sampling and precise fluid dividing in biochips.

2. The quantitative collecting and depositing device for very small fluids according to claim 1, wherein when cleaning the pipelines thereof, the quantitative depositing valves are in an open status and the two electromagnetic valves are in a perpetually open status; the pipelines are rinsed and cleaned by the high-pressure air and high-pressure water through controls of the main PC base controller or the PLC.

3. The quantitative collecting and depositing device for very small fluids according to claim 1, wherein when drying the pipelines thereof, the quantitative depositing valves are in an open status, and one electromagnetic valve is in a perpetually shut status whereas the other electromagnetic valve is in a perpetually open status; the pipelines are dried and the remaining fluids are removed by the high-pressure air through controls of the main PC base controller or the PLC, thereby preventing congestions of the pipelines and cross-contaminations of different fluids.

4. The quantitative collecting and depositing device for very small fluids according to claim 1, wherein the controlling method through the PLC may also be structure of a main PC base controller controlling a plurality of PLC's.
